(19) United States
(12) Patent Application Publication
(10) Pub. No.: US 2008/0235712 A1
(43) Pub. Date: Sep. 25, 2008

(54) Hardware Object Request Broker on a Chip for Generating Separate Control and Data Channels for Improved Throughput Efficiency

(75) Inventors: Jeffrey H. Reed, Blacksburg, VA (US); Pablo M. Robert, Blacksburg, VA (US)

Correspondence Address: WHITHAM, CURTIS & CHRISTOFFERSON & COOK, P.C., 11491 SUNSET HILLS ROAD, SUITE 340, RESTON, VA, 20190, US

(73) Assignee: VIRGINIA TECH INTELLECTUAL PROPERTIES, INC., Blacksburg, VA (US)

(21) Appl. No.: 10/598,580

(22) PCT Filed: Mar. 3, 2005
(86) PCT No.: PCT/US2005/006788

§ 371 Date: Apr. 18, 2008

Related U.S. Application Data
(60) Provisional application No. 60/549,942, filed on Mar. 5, 2004.

(51) Int. Cl. G06F 9/54

(52) U.S. Cl. 719/328

(57) ABSTRACT

A method and apparatus are disclosed for separating the functionality of middleware (320) in a device with embedded resources (341,342) so that data transfer between embedded resources used by an object (330) resident in a general purpose processor (310) of the device takes place directly, thereby minimizing bandwidth overhead at the general purpose processor. The control interface (371,372) for an embedded resource resides in the general purpose processor and uses the device driver of the embedded resource, whereas the data interface (381,382) is outside the general purpose processor and provides direct communication with a switch matrix (360) serving each embedded resource.

### BACKGROUND OF THE INVENTION

1. Field of the Invention

The present invention generally relates to middleware techniques for tying together different software objects, and more particularly to hardware techniques for enhancing middleware in devices with embedded resources.

2. Background Description

Middleware is software that connects two or more otherwise separate applications across the Internet or local area networks, enabling the seamless integration of the separate applications. Typically, middleware provides services for managing security, access and information exchange so that a user of one application, having satisfied the security and access requirements of the application, is able to communicate with another application without separately satisfying the security and access requirements of the other application. Middleware hides the underlying complexity of managing the interaction between remote resources, thereby smoothing the development path for new networked applications combining these resources.

For example, middleware enabled a disbursed community of physicists at different facilities across the globe to pool their computing resources to create a common grid for analysis of enormous amounts of data produced at the CERN high energy physics laboratory. Similarly, middleware services deployed across institutions of higher education enable students at one institution to have remote access to libraries and classroom content at other institutions without separate logins at each institution. Such services are also in evidence for drivers using electronic sensors to pass through toll gates in multiple jurisdictions.

The underlying assumption of middleware implementations is for “bridging the gap between the operating system and the application, easing the development of distributed applications.” While this architectural assumption has been useful in the development of the vast array of middleware implementations available today (e.g. Common Object Request Broker Architecture, or “CORBA”), each publicly available middleware implementation is based on the concept that an object or process residing in a microprocessor's operating system interfaces with other objects or processes residing on the same or other microprocessors.

The extension of this middleware into the embedded world revolves around the implementation of a driver on the microprocessor, creating a platform-specific connection between the object or process residing in the microprocessor and the embedded device. In the context of traditional distributed applications, this architecture makes sense. However, for embedded devices this architectural assumption highlights inefficiencies that lead to higher power consumption for a given throughput.

For example, radio equipment provides wireless communication and, in the current state of the art, commonly uses computers for encoding and decoding data and controlling embedded devices. The set of technologies for computer defined modulation and demodulation of wireless data is called Software Defined Radio (SDR). Incompatibility and upgrade difficulty with radio equipment used for communication has prompted the military to define a middleware standard called Software Communications Architecture (SCA) in order to meet the objectives of the Joint Tactical Radio System (JTRS). This standard defines interfaces that allow waveform applications (i.e. signal conventions for encoding data sent over a wireless communication channel) to run on multiple hardware sets. When connected to a JTRS network, radio equipment compliant with SCA is able to interoperate with other SCA compliant radio equipment independently developed and procured.

In order to obtain interoperability, the data flowing from one embedded device to another is channeled through the on-board computer, resulting in a substantial bandwidth overhead. What is needed is a method for reducing this overhead.

### SUMMARY OF THE INVENTION

It is therefore an object of the present invention to provide a structure and method for reducing the bandwidth overhead from using middleware with embedded devices.

A further object of the invention is to enable a more efficient connection between embedded devices supported by middleware.

Another object of the invention is to provide an easy upgrade path for interoperating equipment supported by middleware by making it relatively easy to add new devices and swap operating devices.

Yet another object of the invention is easier integration of reconfigurable computing platforms, and to isolate reconfigurable computing modules.

It is also an object of the invention to allow direct connection of different platforms with little overhead in a general purpose processor.

A further object of the invention is to provide for extension of middleware connections outside the general purpose processor, thereby allowing for efficient embodiment of customized connectivity approaches.

Another object of the invention is to ease restrictions required to support power management on middleware supported systems having embedded devices.

It is also an object of the invention to make it easier to integrate ASICs cores into system design.

A further object of the invention is to reduce the implementation cost of middleware supported devices having imbedded resources.

Yet another object of the invention is to increase scalability of design by reducing the impact of bandwidth bottlenecks at the general purpose processor of middleware supported systems having embedded devices.

All current implementations of middleware are designed explicitly to isolate different objects from each other and, hence, use a centralized form of control. By extending the functionality of the middleware into the interface of each of these objects and establishing a separate but controlled data channel, the present invention provides a solution aligned with the foregoing objects and suited particularly to middleware supported systems having imbedded devices.

An aspect of the invention is an Object Request Broker (ORB) on a chip for controlling data transfer between embedded resources in a device using the ORB. The ORB on a chip separates the functionality of the ORB into a control interface and a data interface. This functionality enables a software object resident on a general purpose processor of the device to transfer data between embedded resources in the device, there being a control interface and a data interface for the object and each of the embedded resources. The ORB on a chip has circuitry for constructing the control interfaces within the general purpose processor of the device, and for constructing data interfaces for the embedded resources outside the general purpose processor, such that data transfer between embedded resources, under control of the object and exercised through the control interfaces, occurs directly without going through the general purpose processor.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a diagram showing a basic computer system architecture.

FIG. 2 is a diagram showing how prior art middleware in a general purpose processor handles messages.

FIG. 3 is a diagram showing extraction of middleware functionality outside the general purpose processor.

### DETAILED DESCRIPTION OF A PREFERRED EMBODIMENT OF THE INVENTION

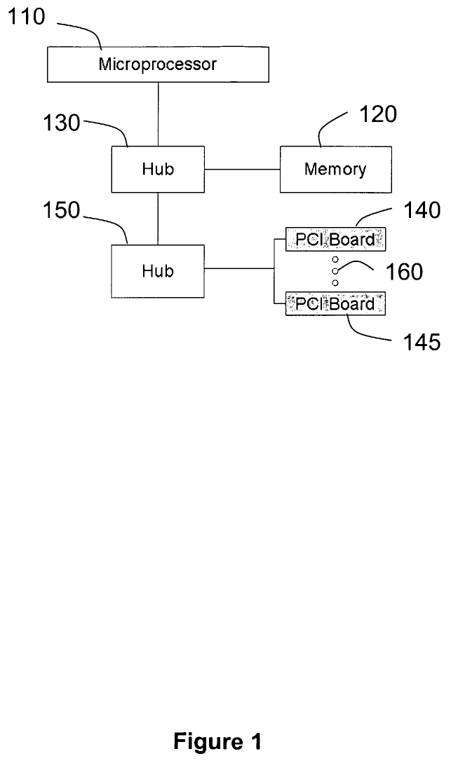

In the case of embedded devices, a basic boundary constraint arises because of the limited ability of the system to support communications between different devices when a microprocessor is used as the core component for interconnections. FIG. 1 shows the basic architecture of a typical personal computer having a microprocessor 110, a memory 120 connected to the microprocessor 110 through a hub 130, and two embedded devices (not shown) residing on PCI boards 140 and 145 (or equivalent structures), respectively, and connected to microprocessor 110 through a hub 150. The two embedded devices can communicate directly through the use of the bus 160. Therefore, the maximum sustainable rate, C, that can be supported by the system is the bus delay, or

$$C ∝ \frac{1}{{τ}_{bus}}$$

However, when the microprocessor 110 is used to inter-connect these embedded devices, the data must be transported from an embedded device to the microprocessor 110 and then back to the target embedded device. Assuming that the data rate between the hub 150 and the microprocessor 110 is much higher than the data rate over the bus 160 between the different embedded devices, then the maximum sustainable rate is now

$$C ∝ \frac{1}{2 \cdot {τ}_{bus} + {τ}_{proc}}$$

where τ_{proc} is the processing delay for managing the communications via the microprocessor 110.

This additional effect can have a significant impact on the overall performance of a system. In combined microprocessor benchmarks and system simulations performed at the Mobile and Portable Radio Research Group at Virginia Polytechnic Institute and State University, the above effect was shown to reduce the supported bandwidth of a radio system by over 85%. This ratio can change depending on the level of granularity controlled by the microprocessor, but the use of microprocessor-centric software can have a large and noticeable impact on the overall performance of a system having embedded devices. In particular, this effect can have a deep impact on Software Defined Radio (SDR) implementations using middleware.

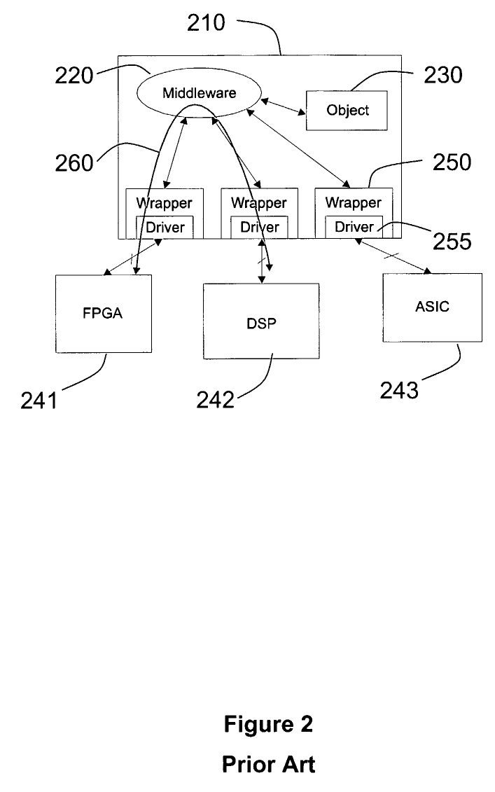

This effect may be further described with reference to FIG. 2, where a general purpose processor (GPP) 210 contains middleware 220. The middleware 220 enables object 230 to use resources such as a Field Programmable Gate Array (FPGA) 241, a Digital Signal Processor (DSP) 242, and an Application Specific Integrated Circuit (ASIC) 243, without having to manage the interactions between these resources. The middleware 220 handles the communication with each of these resources through a respective wrapper 250 and device driver 255. However, data flowing between these resources passes through the general purpose processor 210 in response to the interoperability functionality of the middleware 220, as is shown by the data flow path 260 between the FPGA 241 and the DSP 242. In general, when two different resources are connected through middleware, regardless of what platform they happen to be implemented on, the GPP 210 must receive, process, and re-transmit all data passed between the two resources.

The problem outlined above can be overcome by making the middleware software gluing these different components together a system-wide implementation, not a microprocessor implementation. To illustrate this approach of the invention, we will use CORBA (Common Object Request Broker Architecture) as an exemplar middleware platform. CORBA is used by the JTRS (Joint Tactical Radio System) in its SCA (Software Communications Architecture) standard. However, while SCA specifications versions 2.2 and lower mandate the use of CORBA, future versions of the SCA will most likely allow use of middleware technologies other than CORBA. As those skilled in the art will appreciate, the invention can be practiced with middleware other than CORBA.

To generate an interface between two objects under the prior art approach using CORBA, separate objects are created using C++, or some other OOP language, as well as an Interface Description Language (IDL) description of the interface methods within that object. This IDL file is used by the supplied code generator (which is specific to the Object Request Broker) to generate the skeleton and stub code for the appropriate object methods. This additional code is then compiled with the target object, generating new executable code that can be connected through CORBA's ORB (Object Request Broker). Using this prior art method, objects residing within the bounds of the operating system, and the current reach of the ORB, are connected.

In contrast, the present invention provides diffuse middleware, that is, an Object Request Broker whose functionality is broken down into two separate pieces, the control and data interfaces. We will call this approach of the invention a “Diffuse ORB”. The control object is written in some language like C++ and interacts with the device drivers. The interfaces for this object are created in the traditional way described above. However, the data interface for the embedded device is handled in a different way. For the purposes of this example, assume that the embedded device is a Field Programmable Gate Array (FPGA) and the system is a software defined radio (SDR). An IDL description of the FPGA's raw interface is written by the developer of the system. The IDL code is then used to generate, through another ORB-specific code generator, bit files that describe both the interface between the core functionality of the FPGA and the bus structure that the FPGA chip is connected to, as well as the controller necessary to perform this functionality.

Another way of looking at this is that the IDL-generated code is used to create a bridge between the FPGA's original interface and the new interface, as well as the desired target for the information or (in the case of an input interface) the required data to receive the information from the source. If no dynamic interfaces are used (which is the case in JTRS), and because the SDR developer needs to know at the time of development the complete structure of the waveform, it is possible to determine which interfaces need to be created and to determine which platform will be used.

From the description provided above, it should be clear that it is possible to build an ORB implementation that maintains all the desirable attributes of CORBA while at the same time giving the system developer the ability to establish separate data (hardware-centric) and control (microprocessor-centric) channels, thus increasing the bandwidth that the system can support, or reducing the overall power consumption expected from the support of a waveform with a given signal bandwidth.

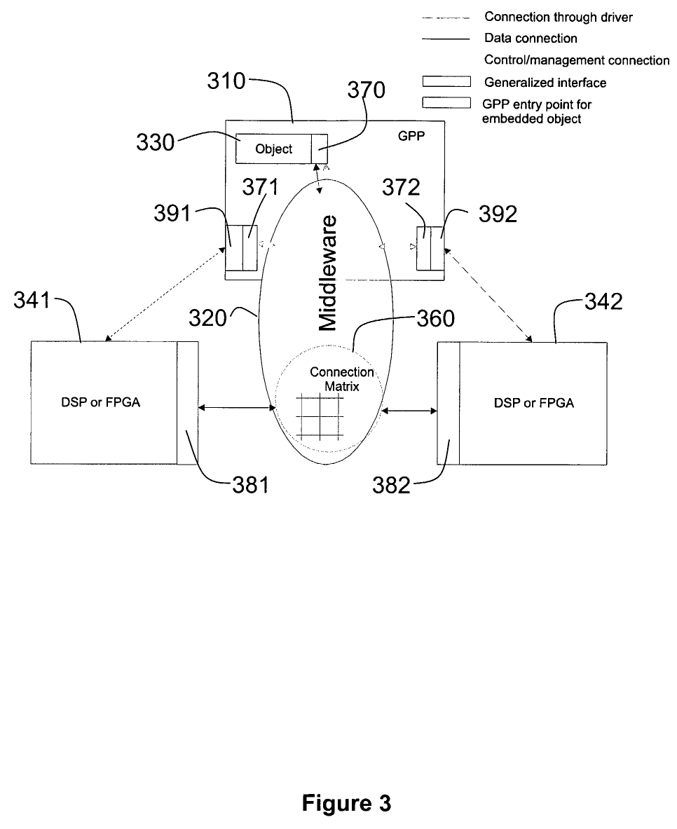

The foregoing aspects of the invention may be further understood with reference to FIG. 3. As with the prior art shown in FIG. 2, there is a general purpose processor 310 on which resides an object 330 using embedded resources 341 and 342. However, as described above, in contrast to the prior art shown in FIG. 2, middleware 320 is structured to break its functionality into separate control (371, 372) and data (381, 382) interfaces. For each embedded resource (341, 342) there is an entry point (391, 392) to the GPP (310), which is used by the control interface (371, 372) via the respective drivers (not shown) to complete a control connection between middleware 320 and the respective embedded resources (341, 342). The data interfaces (381, 382) of the middleware 320 are provided in a different manner, being extracted outside of the GPP 310. A hardware switch matrix 360 is provided for the device (e.g. an SDR), allowing different hardware components of the device (i.e. embedded resources 341 and 342) to communicate directly. The switch matrix 360 is a custom fabric that is used for the connection of multiple devices within a core or set of cores. By integrating the switch matrix 360 into middleware 320, the switch matrix becomes a channel of communication integral to the middleware 320.

Taking one embedded resource as an example, the control interface 371 for embedded resource 341 will interact with the device driver (not shown) for embedded resource 341 at a GPP entry point 391. The connection between the embedded resource 341 and the GPP entry point 391 is made through the device driver (not shown), and this connection is used for implementing the control functionality of middleware 320 through control interface 371. The data interface 381 of middleware 320 is moved outside GPP 310 by use within middleware 320 of switch matrix 360, enabling direct data connection between embedded resource 341 and any other embedded resources within the device served by GPP 310.

The approach of the invention offers the capability of leveraging the best aspects of middleware such as CORBA, namely, coupling CORBA's ability to provide an abstraction for the connection of different modules with the high-speed and energy efficiency associated with connections established by embedded custom code.

To reduce the implementation cost of an SDR, the Diffuse ORB concept may be extended to a hardware ORB, or an ORB-on-a-chip (OOC). This chip is custom-designed to support hardware connectivity provided by switch matrix 360, e.g. in an SDR framework.

A Diffuse ORB is used to provide the software architecture for the development of the waveform, while the underlying hardware of the system provides an efficient connectivity structure that is custom-tailored to an SDR application. It should be noted that an OOC is not a stand-alone solution. For this concept to work, it still requires a microprocessor to provide configuration and management information. In this sense, an OOC can be considered as a communications co-processor.

To achieve an efficient OOC solution, the Diffuse ORB concept requires development of the appropriate ORB and IDL code generators. Further, as will be evident to those skilled in the art, a specific solution for the switch matrix can take one of many forms, such as a connection fabric, bus, shared memory, or some other structure not yet created.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A hardware Object Request Broker (ORB) on a chip for controlling data transfer between embedded resources in a device, comprising:
first integrated circuit means for separating a functionality of said ORB into a control interface and a data interface, said ORB functionality enabling a software object resident on a general purpose processor of said device to transfer data between said embedded resources, there being a control interface and a data interface for each of said object and each of said embedded resources;
second integrated circuit means for constructing said control interfaces within said general purpose processor of said device;
third integrated circuit means for constructing said data interfaces for said embedded resources outside said general purpose processor, such that said data transfer, under control of said object exercised through said second integrated circuit means, occurs directly between said embedded resources without going through said general purpose processor.

2. A hardware Object Request Broker (ORB) on a chip as in claim 1, wherein said respective control interfaces for each of said embedded resources are implemented using device drivers of said respective embedded resources.

3. A hardware Object Request Broker (ORB) on a chip as in claim 1, wherein said respective data interfaces for each of said embedded resources are each connected to a switch matrix, said switch matrix being external to said general purpose processor and serving to connect said embedded resources.

4. A hardware Object Request Broker (ORB) on a chip as in claim 3, wherein said switch matrix is implemented as a connection fabric.

5. A hardware Object Request Broker (ORB) on a chip as in claim 3, wherein said switch matrix is implemented as a shared memory.

6. A hardware Object Request Broker (ORB) on a chip as in claim 1, wherein said device is a software defined radio, said given system is the Joint Tactical Radio System, and said ORB is compliant with Software Communications Architecture (SCA).

7. A hardware Object Request Broker (ORB) on a chip as in claim 3, wherein one of said embedded resources is a Field Programmable Gate Array (FPGA).

8. A hardware Object Request Broker (ORB) on a chip as in claim 7, further comprising:
fourth integrated circuit means for creating an Interface Description Language (IDL) description of a raw interface of said FPGA;
fifth integrated circuit means for generating from said IDL a description of an interface between a core functionality of said FPGA and said switch matrix, and a description of a controller for performing said core functionality; and
sixth integrated circuit means for integrating said core functionality interface into said data interface of said FPGA, and integrating said controller into said control interface of said FPGA.
